(19) United States
(12) Patent Application Publication
(10) Pub. No.: US 2022/0290611 A1
(43) Pub. Date: Sep. 15, 2022

(54) GAS TURBINE COMBUSTOR, GAS TURBINE, AND COMBUSTION METHOD FOR OIL FUEL

(71) Applicant: Mitsubishi Heavy Industries, Ltd., Tokyo (JP)

(72) Inventors: Soichi HATORI, Kanagawa (JP); Koichi NISHIDA, Kanagawa (JP); Masaki MITANI, Kanagawa (JP)

(21) Appl. No.: 17/639,762

(22) PCT Filed: Oct. 2, 2020
(86) PCT No.: PCT/JP2020/037490

§ 371 Date: Mar. 2, 2022

(30) Foreign Application Priority Data
Oct. 4, 2019 (JP) 2019-183413

(51) Int. Cl. F02C 7/22; F23R 3/48; F23R 3/28

(52) U.S. Cl. CPC F02C 7/22; F23R 3/48; F23R 3/28; F05D 2220/32

(57) ABSTRACT

A gas turbine combustor according to at least one embodiment of the present disclosure includes a first burner with a plurality of first nozzles disposed along an inner circumference of a cylindrical combustion tube, and a second nozzle surrounded by the plurality of first nozzles. The second nozzle has a fuel injection hole capable of injecting fuel. A distance between a centroid of the fuel injection hole and an outer peripheral edge of the fuel injection hole as viewed from an axial direction of the combustion tube differs depending on a position of the outer peripheral edge in a circumferential direction of the combustion tube.

### TECHNICAL FIELD

The present disclosure relates to a gas turbine combustor, a gas turbine, and a combustion method for oil fuel.

### BACKGROUND

A combustor constituting a gas turbine is disposed in a casing where compressed air produced by a compressor is introduced. The combustor produces a high-temperature and high-pressure combustion gas in a tubular combustion tube. A plurality of combustors are disposed to be adjacent to each other in the circumferential direction of a turbine to which the combustion gas is supplied (see, for example, Patent Document 1).

### CITATION LIST

### Patent Literature

Patent Document 1: JP2015-129490A

### SUMMARY

### Technical Problem

Increasing a turbine inlet temperature to increase an output of a gas turbine increases a combustion vibration, hindering the increase in output of the gas turbine. Hence, suppressing the combustion vibration is required.

In view of the above, an object of at least one embodiment of the present disclosure is to provide a gas turbine combustor capable of suppressing the combustion vibration.

### Solution to Problem

(1) A gas turbine combustor according to at least one embodiment of the present disclosure includes a first burner with a plurality of first nozzles disposed along an inner circumference of a cylindrical combustion tube, and a second nozzle surrounded by the plurality of first nozzles. The second nozzle has a fuel injection hole capable of injecting fuel. A distance between a centroid of the fuel injection hole and an outer peripheral edge of the fuel injection hole as viewed from an axial direction of the combustion tube differs depending on a position of the outer peripheral edge in a circumferential direction of the combustion tube.

(2) A gas turbine combustor according to at least one embodiment of the present disclosure includes a first burner with a plurality of first nozzles disposed along an inner circumference of a cylindrical combustion tube, and a second nozzle surrounded by the plurality of first nozzles. The second nozzle has a fuel injection hole capable of injecting fuel, and is capable of injecting the fuel injected from the fuel injection hole such that a spray shape of the fuel has a longest first major axis passing through a first centroid which is a centroid of the spray shape, and a first minor axis passing through the first centroid, as well as being orthogonal to the first major axis and shorter than the first major axis, in a cross-section orthogonal to a central axis of the combustion tube.

(3) A gas turbine according to at least one embodiment of the present disclosure includes a rotor, and a plurality of combustors according to the above configuration (1) or (2) disposed in an annular shape around the rotor.

(4) A combustion method for oil fuel according to at least one embodiment of the present disclosure is a combustion method for oil fuel in a gas turbine, which includes a step of injecting the oil fuel from a plurality of first nozzles disposed along an inner circumference of a cylindrical combustion tube in a first burner with the plurality of first nozzles, and a step of injecting the oil fuel from a fuel injection hole of a second nozzle surrounded by the plurality of first nozzles. The step of injecting the oil fuel from the fuel injection hole includes injecting the oil fuel injected from the fuel injection hole such that a spray shape of the oil fuel has a longest major axis passing through a centroid of the spray shape, and a minor axis passing through the centroid, as well as being orthogonal to the major axis and shorter than the major axis, in a cross-section orthogonal to a central axis of the combustion tube.

### Advantageous Effects

According to at least one embodiment of the present disclosure, it is possible to suppress a combustion vibration.

### BRIEF DESCRIPTION OF DRAWINGS

FIG. 1 is a schematic configuration view of a gas turbine according to an embodiment of the present disclosure.

FIG. 2 is a view for describing a peripheral configuration of a combustor of the gas turbine.

FIG. 3 is a schematic view showing a cross-section in the vicinity of a combustion tube (combustor basket) along the axial direction of the combustor basket.

FIG. 4 is a schematic view showing an IV-IV arrow cross-section in FIG. 3.

FIG. 5 is a schematic view showing a V-V arrow cross-section in FIG. 3.

FIG. 6 is a view of two combustors adjacent to each other along the circumferential direction of the gas turbine.

FIG. 7 is a schematic view showing a cross-section in the vicinity of a tip of a pilot nozzle along the axial direction along according to some embodiments.

FIG. 8 is a view of a VIII arrow cross-section in FIG. 7.

FIG. 9 is a schematic perspective view of a spray nozzle according to some embodiments.

FIG. 10 is a view for describing a spray shape of fuel injected from a fuel injection hole of the spray nozzle according to some embodiments.

FIG. 11 is a view for describing a flow of water injected from a water injection hole of an atomizing cap.

FIG. 12 is a view showing an example of a desirable shape of a spray shape of the water injected from the water injection hole.

FIG. 13 is a schematic view of a cross-section orthogonal to a central axis of the combustion tube at an axial position of an outlet opening of an extension pipe as viewed from an axially downstream side.

FIG. 14 is a schematic view of the cross-section orthogonal to the central axis of the combustion tube at the axial position of the outlet opening of the extension pipe as viewed from the axially downstream side.

FIG. 15 is a cross-sectional view at an axial position where a connecting pipe exists.

FIG. 16 is a schematic view for describing fuel swirl in the combustion tube.

FIG. 17 is a cross-sectional view at the axial position where the connecting pipe exists.

FIG. 18 is a flowchart showing a processing procedure in a combustion method for oil fuel according to an embodiment.

### DETAILED DESCRIPTION

Embodiments of the present disclosure will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same”, “equal”, and “uniform” shall not be construed as indicating only the state in which the feature is strictly equal, but also includes a state in which there is a tolerance or a difference that can still achieve the same function.

Further, for instance, an expression of a shape such as a rectangular shape or a tubular shape shall not be construed as only the geometrically strict shape, but also includes a shape with unevenness or chamfered corners within the range in which the same effect can be achieved.

On the other hand, the expressions “comprising”, “including”, “having”, “containing”, and “constituting” one constituent component are not exclusive expressions that exclude the presence of other constituent components.

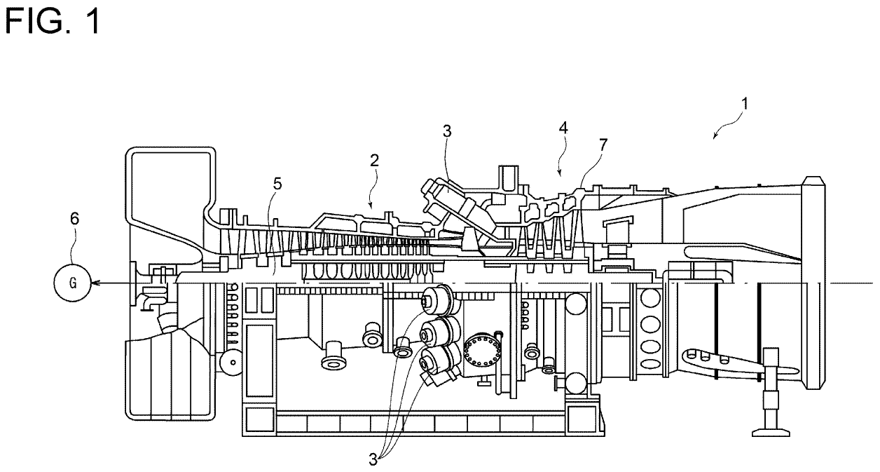

FIG. 1 is a schematic configuration view of a gas turbine according to an embodiment of the present disclosure.

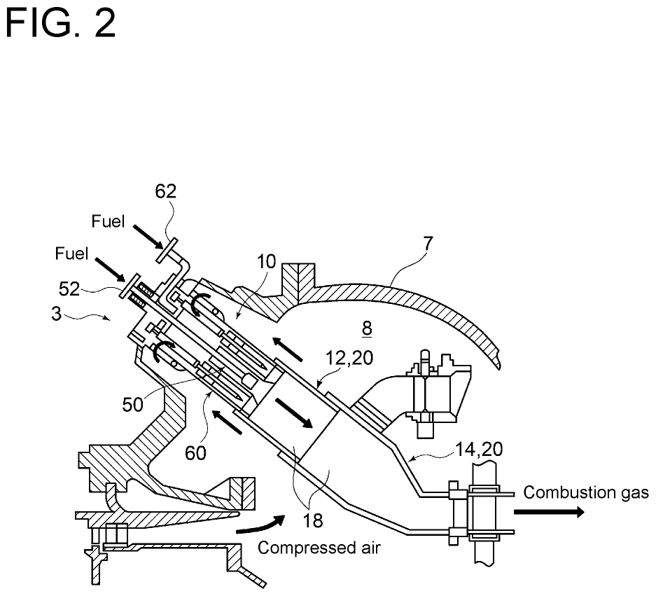

FIG. 2 is a view for describing a peripheral configuration of a combustor of the gas turbine.

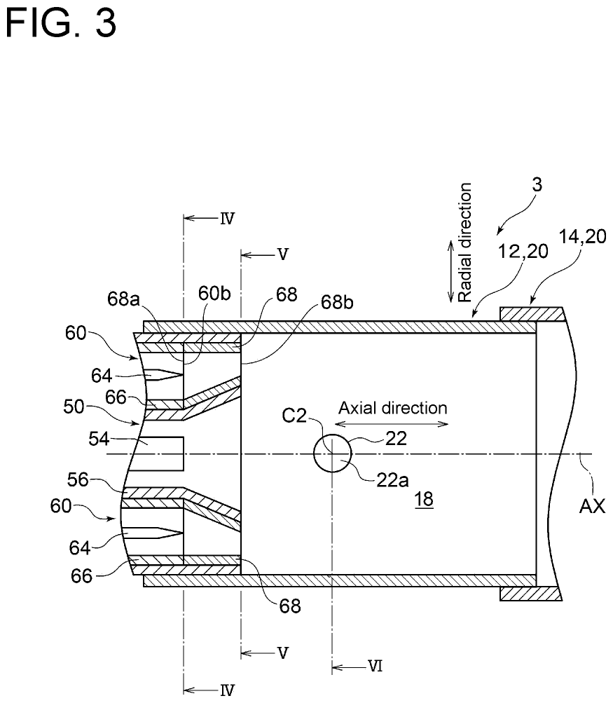

FIG. 3 is a schematic view showing a cross-section in the vicinity of a combustion tube (combustor basket) along the axial direction of the combustor basket.

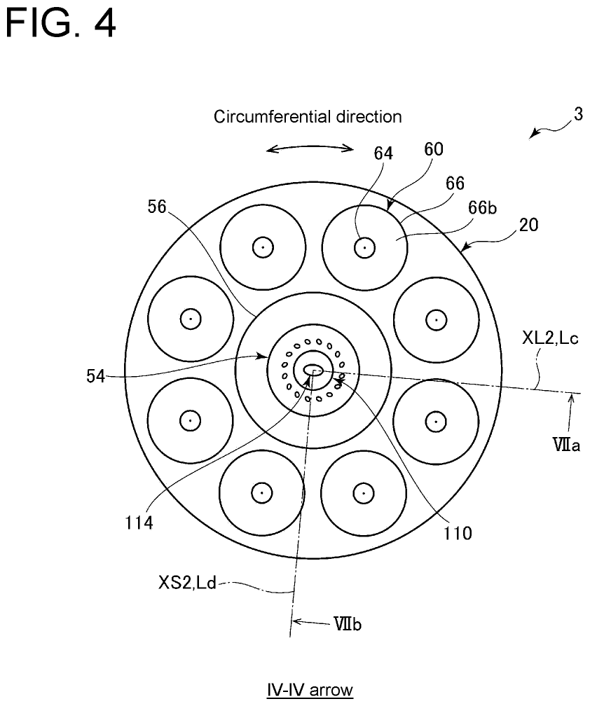

FIG. 4 is a schematic view showing an IV-IV arrow cross-section in FIG. 3.

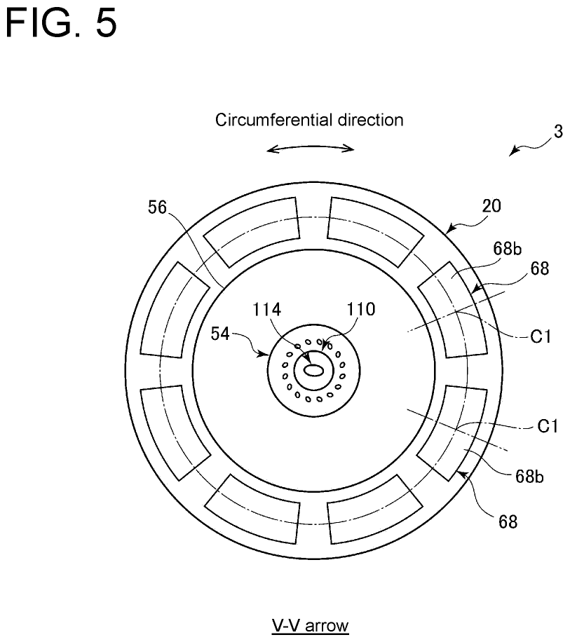

FIG. 5 is a schematic view showing a V-V arrow cross-section in FIG. 3.

(Regarding Gas Turbine 1)

As shown in FIG. 1, a gas turbine 1 according to the present embodiment includes a compressor 2, a combustor 3, and a turbine 4 and drives an external device such as a generator G. In the case of the gas turbine 1 for power generation, a generator G is connected to a rotor 5.

The compressor 2 sucks in and compresses atmosphere which is external air, and supplies the compressed air to at least one combustor 3.

The combustor 3 combusts fuel supplied from outside with the air compressed by the compressor 2, thereby producing a high-temperature gas (combustion gas). In the gas turbine 1 according to an embodiment, the plurality of combustors 3 are disposed in an annular shape around the rotor 5. In the gas turbine 1 according to an embodiment, oil fuel (liquid fuel) which is a flammable liquid is used as fuel, but a gaseous fuel which is a flammable gas may be used as fuel.

The turbine 4 generates a rotational driving force in response to supply of the high-temperature combustion gas produced by the combustor 3, and outputs the generated rotational driving force to the compressor 2 and the external device.

As shown in FIG. 2, in a casing 7, a combustor installation space 8 of the combustor 3 is provided. The combustor installation space 8 is located between an outlet of the compressor 2 on an axially upstream side and an inlet of the turbine 4 on an axially downstream side. The combustor 3 is disposed in the combustor installation space 8, and the compressed air flows into the combustor 3 from one end side of the combustor 3. On the other hand, fuel is supplied to the combustor 3 from the outside, the fuel and air are mixed to produce a high-temperature combustion gas, and the combustion gas rotary drives the turbine 4 on the downstream side.

More specifically, the combustor 3 according to some embodiments includes a nozzle portion 10 and a combustion tube 20. The combustion tube 20 includes a combustor basket 12 and a transition piece 14. The combustor basket 12 and the transition piece 14 may integrally be formed. The combustion tube 20 internally includes a combustion chamber 18 where fuel injected from a main nozzle 64 and a pilot nozzle 54 to be described later is combusted.

The nozzle portion 10 includes a pilot burner 50 and a plurality of main burners (premixed combustion burners) 60. In the following description, the main burner 60 will also be referred to as the first burner 60, and the pilot burner 50 will also be referred to as the second burner 50.

The pilot burner 50 is disposed along a central axis AX of the combustion tube 20.

Then, the plurality of main burners 60 are arranged at a distance from one another so as to surround the pilot burner 50.

The pilot burner 50 includes the pilot nozzle (second nozzle) 54 connected to a fuel port 52, a pilot nozzle tube (second nozzle tube) 56 disposed so as to surround the pilot nozzle 54, and a swirler (not shown) disposed on the outer periphery of the pilot nozzle 54. The specific configuration of the pilot burner 50 will be described later.

The main burner 60 includes the main nozzle (first nozzle) 64 connected to a fuel port 62, a main nozzle tube (first nozzle tube) 66 disposed so as to surround the main nozzle 64, and a swirler (not shown) disposed on the outer periphery of the main nozzle 64.

The main burner 60 according to some embodiments includes a plurality of extension pipes 68 each having an inlet opening 68a that coincides with an outlet side opening 66b of the main nozzle tube 66 and an annular fan-shaped outlet opening 68b. The inlet opening 68a of the extension pipe 68 is connected to the outlet side opening 66b of the main nozzle tube 66.

In the combustor 3 having the above configuration, the compressed air produced by the compressor 2 is supplied into the combustor installation space 8, and further flows into the main nozzle tube 66 from the combustor installation space 8. Then, the compressed air and the fuel supplied from the fuel port 62 are premixed in the main nozzle tube 66. At this time, the premixed air is mainly formed into a swirl flow by the swirler (not shown), and flows into the combustor basket 12. Further, the compressed air and the fuel injected from the pilot burner 50 via the fuel port 52 are mixed, and ignited by pilot light (not shown) to be combusted, producing a combustion gas. At this time, a part of the combustion gas diffuses to the surroundings with flames, thereby being ignited by the premixed air flowing into the combustor basket 12 from each main burner 60 and being combusted. That is, the pilot flames produced by the pilot fuel injected from the pilot burner 50 can secure flames for performing stable combustion of the premixed air (premixed fuel) from the main burner 60.

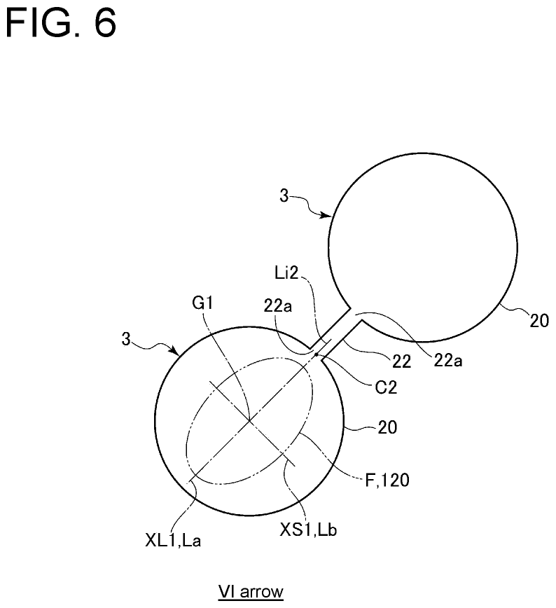

FIG. 6 is a view of two combustors 3, of the plurality of combustors 3 disposed in the annular shape around the rotor 5 of the gas turbine 1, adjacent to each other along the circumferential direction of the gas turbine 1. FIG. 6 is a schematic cross-sectional view showing a VI arrow cross-section in FIG. 3. Each of the plurality of combustors 3 according to some embodiments is mounted with a connecting pipe 22 for propagating a flame from one of the two adjacent combustors 3 to the other.

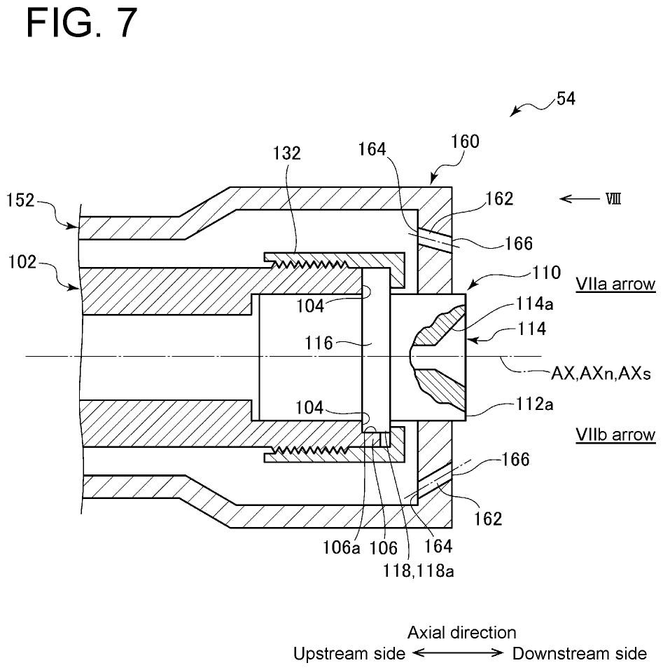

FIG. 7 is a schematic view showing a cross-section in the vicinity of a tip of the pilot nozzle 54 along the axial direction along according to some embodiments. In FIG. 7, a cross-section above the central axis AX of the combustion tube 20 represents a VIIa arrow cross-section in FIG. 4, and a cross-section below the central axis AX of the combustion tube 20 represents a VIIb arrow cross-section in FIG. 4. Further, in FIG. 7, for illustrative convenience, the description of a seal member or the like for preventing leakage of fuel and water flowing inside the pilot nozzle 54 is omitted.

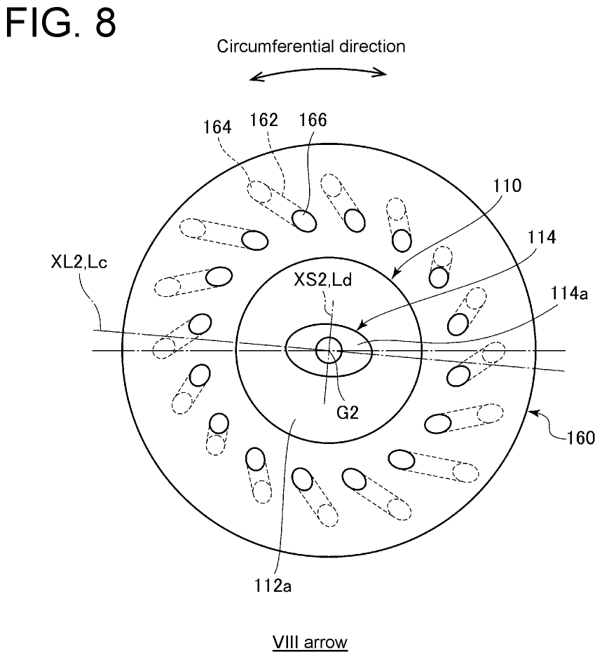

FIG. 8 is a view of a VIII arrow cross-section in FIG. 7. That is, FIG. 8 is a view when the pilot nozzle 54 is viewed from the downstream side toward the upstream side in the axial direction according to some embodiments.

In the following description, an extension direction of the central axis AX of the combustion tube 20 may simply be referred to as an extension direction, the circumferential direction centered on the central axis AX may simply be referred to as the circumferential direction, and the radial direction centered on the central axis AX may simply be referred to as the radial direction.

The pilot nozzle 54 according to some embodiments has a double pipe structure, and includes an inner pipe 102 and an outer pipe 152.

The inner pipe 102 is connected to the fuel port 52. The inner pipe 102 is mounted at a downstream end 104 with a spray nozzle 110. The spray nozzle 110 according to some embodiments is disposed along a central axis AXn of the pilot nozzle 54.

The outer pipe 152 is connected to a water supply piping (not shown). The outer pipe 152 is mounted at downstream end thereof with an atomizing cap 160 to be described later.

(Regarding Spray Nozzle 110)

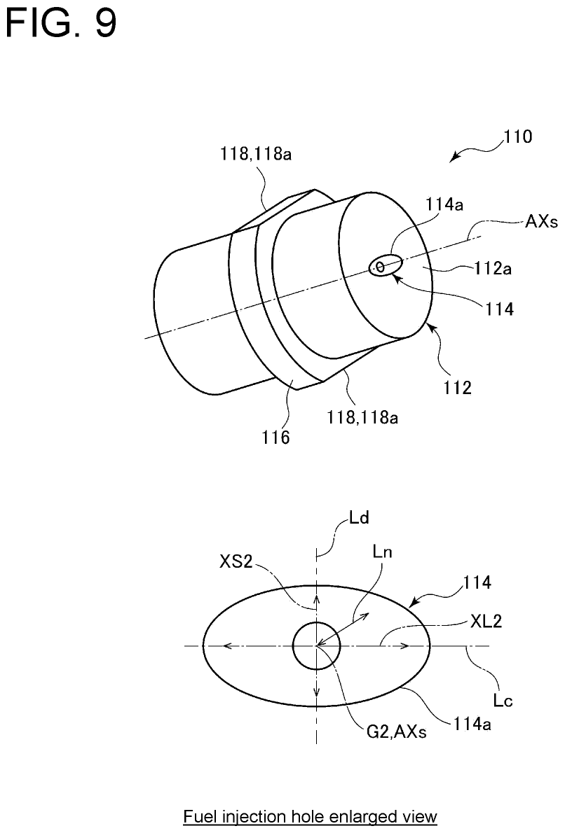

FIG. 9 is a schematic perspective view of the spray nozzle 110 according to some embodiments. FIG. 9 also shows an enlarged view of a fuel injection hole 114 of the spray nozzle 110.

In the spray nozzle 110 according to some embodiments, the fuel injection hole 114 is formed at the tip of a spray nozzle body 112 having a cylindrical shape, for example. In the spray nozzle body 112, a flange portion 116 is formed which protrudes the radially outward side of the spray nozzle body 112 from the outer circumferential surface. In the flange portion 116, notches 118 are formed at every 180 degrees along the circumferential direction of the flange portion 116. The notches 118 each include a flat surface portion 118a facing radially outward of the spray nozzle body 112.

The fuel injection hole 114 of the spray nozzle 110 according to some embodiments has an inclined surface 114a formed so as to be directed to the radially outer side of the spray nozzle body 112 from the inside of the spray nozzle body 112 toward a tip 112a of the spray nozzle body 112 along an axis AXs direction of the spray nozzle body 112. The inclined surface will also be referred to as an outer peripheral edge 114a.

In the fuel injection hole 114 of the spray nozzle 110 according to some embodiments, a distance Ln between the outer peripheral edge 114a of the fuel injection hole 114 and a centroid (second centroid) G2 of the fuel injection hole 114 as viewed from the axial direction of the spray nozzle body 112 differs depending on the position of the outer peripheral edge 114a in the circumferential direction of the spray nozzle body 112. For example, in the fuel injection hole 114 of the spray nozzle 110 according to some embodiments, the outer peripheral edge 114a is preferably formed to have a longest major axis (second major axis) XL2 passing through the second centroid G2, and a minor axis (second minor axis) XS2 passing through the second centroid G2, as well as being orthogonal to the second major axis XL2 and shorter than the second major axis XL2, as viewed from the axial direction of the spray nozzle body 112. As an example of the shape of such outer peripheral edge 114a, as is well shown in FIG. 9, the shape of the outer peripheral edge 114a as viewed from the axial direction of the spray nozzle body 112 may be an elliptical shape.

The shape of the outer peripheral edge 114a as viewed from the axial direction of the spray nozzle body 112 may be any of various shapes, which has a rotationally symmetric property, other than the elliptical shape.

For descriptive convenience, in the following description, a straight line including the second major axis XL2 will be referred to as a straight line Lc, and a straight line including the second minor axis XS2 will be referred to as a straight line Ld.

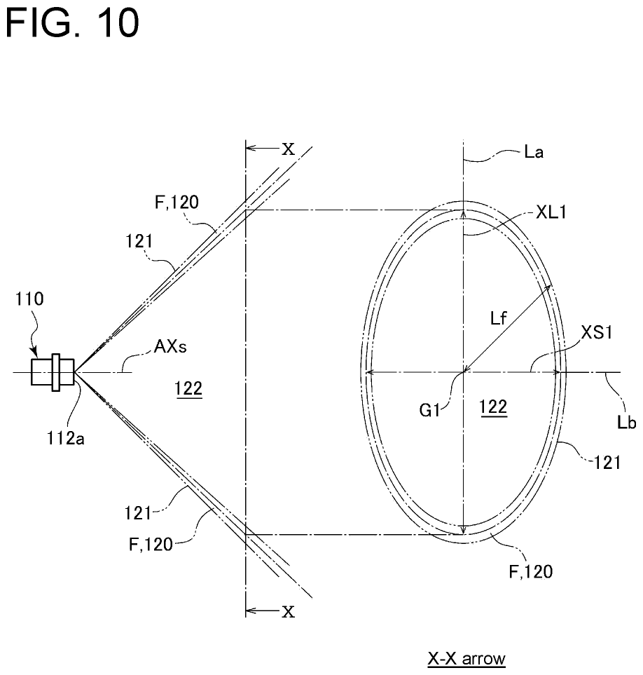

FIG. 10 is a view for describing a spray shape of fuel injected from the fuel injection hole 114 of the spray nozzle 110 according to some embodiments.

In the spray nozzle 110 according to some embodiments, fuel F supplied from the fuel port 52 via the inner pipe 102 can be injected from the fuel injection hole 114.

If the fuel F is injected from the fuel injection hole 114, a spray shape 120 of the fuel F becomes a shape corresponding to the shape of the fuel injection hole 114. More specifically, in the spray nozzle 110 according to some embodiments, in a cross-section where the spray shape 120 of the fuel F injected from the fuel injection hole 114 is orthogonal to the axis AXs of the spray nozzle body 112 (for example, an X-X arrow cross-section in FIG. 10), a distance Lf between a first centroid G1 which is a centroid of the spray shape 120 and an outer edge 121 of the spray shape 120 differs depending on a position of the outer edge 121 in the circumferential direction centered on the axis AXs.

For example, in the spray nozzle 110 according to some embodiments, in the cross-section orthogonal to the axis AXs of the spray nozzle body 112, that is, the central axis AX of the combustion tube 20, it is preferable that the fuel F can be injected such that the spray shape 120 of the fuel F has a longest first major axis XL1 passing through the first centroid G1, and a first minor axis XS1 passing through the first centroid G1, as well as being orthogonal to the first major axis XL1 and shorter than the first major axis XL1.

For example, in the spray nozzle 110 according to some embodiments, the spray shape 120 of the fuel F is preferably an elliptical shape in the cross-section orthogonal to the central axis of the combustion tube.

The spray shape 120 of the fuel F may be any of various shapes, which has a rotationally symmetric property, other than the elliptical shape.

The spray shape 120 of the fuel F may be, for example, as shown in FIG. 10, the hollow spray shape 120 in which a conical-shaped region 122 where the fuel F does not exist is formed, or may be a solid spray shape 120 although not shown.

For descriptive convenience, in the following description, a straight line including the first major axis XL1 will be referred to as a straight line La, and a straight line including the first minor axis XS1 will be referred to as a straight line Lb.

(Regarding Positioning of Spray Nozzle 110)

In the pilot nozzle 54 according to some embodiments, an angular position of the spray nozzle 110 centered on the central axis AXn of the pilot nozzle 54 is predetermined such that the first major axis XL1 and first minor axis XS1 described above extend in a predetermined direction in the combustor 3, for example. The pilot nozzle 54 according to some embodiments has the following configuration such that the angular position of the spray nozzle 110 becomes the predetermined angular position.

That is, in the pilot nozzle 54 according to some embodiments, as shown in FIG. 7, a protrusion 106 protruding in the axial direction of the inner pipe 102 is formed at the downstream end 104 of the inner pipe 102. In some embodiments, the protrusions 106 are formed every 180 degrees along the circumferential direction of the inner pipe 102, and each include a flat surface portion 106a facing radially inward of the inner pipe 102.

In some embodiments, the protrusion 106 and the notch 118 of the spray nozzle 110 are configured such that the flat surface portion 106a of the protrusion 106 and the flat surface portion 118a of the notch 118 are brought into contact with each other, if the spray nozzle 110 is mounted at the downstream end 104 of the inner pipe 102. Therefore, in some embodiments, it is possible to position the angular position of the spray nozzle 110 at the predetermined angular position by the protrusion 106 and the notch 118.

In some embodiments, the spray nozzle 110 connects a mounting nut 132 to a male screw portion formed on the outer peripheral surface of the inner pipe 102 in the vicinity of the downstream end of the inner pipe 102, thereby interposing the flange portion 116 between the mounting nut 132 and the downstream end 104 of the inner pipe 102, and fixing the flange portion 116 to the inner pipe 102.

(Regarding Atomizing Cap 160)

For example, as shown in FIG. 7, in some embodiments, the atomizing cap 160 capable of injecting water is mounted at the downstream end of the outer pipe 152 in order to suppress nitrogen oxides in the combustion gas.

The atomizing cap 160 according to some embodiments has a plurality of water injection holes 162 capable of injecting water supplied via the outer pipe 152 into the combustion chamber 18, for example, as shown in FIG. 8. The plurality of water injection holes 162 have water inlet openings 164 and water outlet openings 166, respectively.

The water outlet openings 166 are disposed at intervals along the circumferential direction on the radially outer side of the fuel injection hole 114. The respective radial positions of the water outlet openings 166 are, for example, the same.

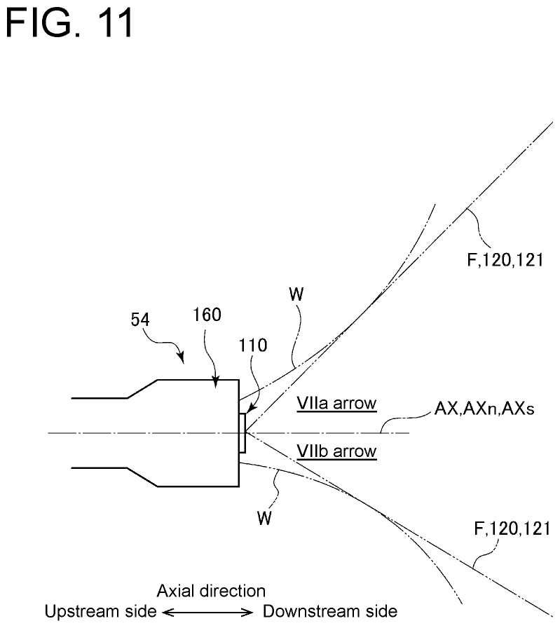

The radial positions of the water inlet openings 164 differ depending on the circumferential positions of the water outlet openings 166, respectively. More specifically, the positions of the water inlet openings 164 and the water outlet openings 166, that is, the extension direction of the water injection holes 162, is set to be able to inject water W along the injection direction of the fuel F in a radially outward region of the fuel F injected from the fuel injection hole 114. FIG. 11 is a view for describing a flow of the water W injected from the water injection hole 162 of the atomizing cap 160. In FIG. 11, a cross-section above the central axis AX of the combustion tube 20 (the central axis AXn of the pilot nozzle 54) represents a VIIa arrow cross-section in FIG. 4, and a cross-section below the central axis AXn of the pilot nozzle 54 represents a VIIb arrow cross-section in FIG. 4.

In some embodiments, for example, if the spray shape 120 of the fuel F has the elliptical shape, an injection shape of the water W injected from the water injection hole 162 preferably also has an elliptical shape.

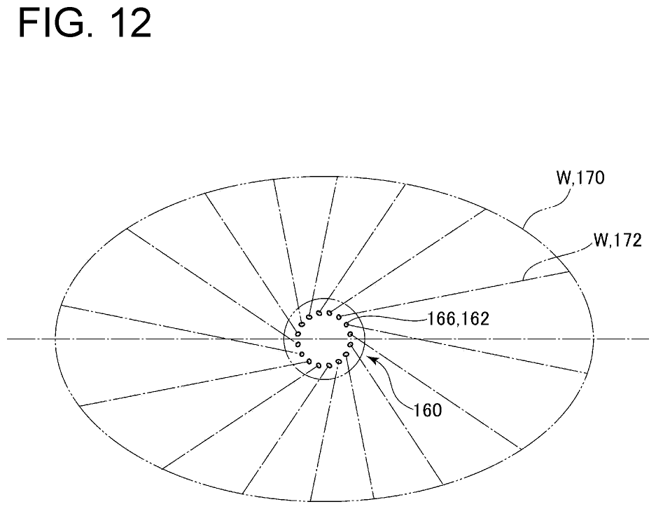

FIG. 12 is a view showing an example of a desirable shape of a spray shape 170 of the water W injected from the water injection hole 162, if the spray shape 120 of the fuel F has the elliptical shape. FIG. 12 shows the spray shape 170 of the water W as viewed from the axially downstream side. The spray shape 170 shown in FIG. 12 is an injection shape that appears in the cross-section orthogonal to the central axis AX of the combustion tube 20 at a certain axial position. In FIG. 12, an alternate long and short dash line 172 extending radially outward from each water outlet opening 166 indicates the locus of the water W injected from a corresponding one of the water injection holes 162.

According to some embodiments, since the radial positions of the water inlet openings 164 differ depending on the circumferential positions of the water outlet openings 166, respectively, it is possible to inject the water W along the injection direction of the fuel F in the radially outward region of the fuel F injected from the fuel injection hole 114. Thus, it is possible to suppress generation of nitrogen oxides due to combustion of the fuel F, while suppressing an influence on the spray shape 120 of the fuel F by the injected water W.

(Regarding Suppression of Combustion Vibration)

Increasing a turbine inlet temperature to increase an output of the gas turbine 1 increases a combustion vibration, hindering the increase in output of the gas turbine 1. Hence, suppressing the combustion vibration is required.

In order to suppress the combustion vibration, it is preferable to make a time until the fuel F injected from the plurality of main nozzles 64 at the same time becomes a flame and vibrates by contacting an inner wall of the combustion tube 20, and a contact position of the flame and the inner wall different depending on the circumferential position.

Thus, in the combustor 3 according to some embodiments, the combustion vibration is suppressed as follows.

For example, the pilot nozzle 54 according to some embodiments includes the fuel injection hole 114 capable of injecting the fuel F. More specifically, the pilot nozzle 54 according to some embodiments includes the spray nozzle 110 where the fuel injection hole 114 is formed at the tip of the spray nozzle body 112.

The pilot nozzle 54 according to some embodiments is configured such that, in the cross-section where the spray shape 120 of the fuel F injected from the fuel injection hole 114 is orthogonal to the central axis AX of the combustion tube 20, the distance Lf between the first centroid G1 and the outer edge 121 of the spray shape 120 differs depending on the position of the outer edge 121 in the circumferential direction.

In the pilot nozzle 54 according to some embodiments, the distance Ln between the second centroid G2, which is the centroid of the fuel injection hole 114, and the outer peripheral edge 114a of the fuel injection hole 114 as viewed from the axial direction may differ depending on the position of the outer peripheral edge 114a in the circumferential direction.

According to such pilot nozzle 54, the spray shape 120 of the fuel F is configured such that, in the cross-section orthogonal to the central axis AX of the combustion tube 20, the distance Lf between the first centroid G1 and the outer edge 121 of the spray shape 120 differs depending on the position of the outer edge 121 of the spray shape 120 in the circumferential direction. That is, the spray shape 120 of the fuel F is not a circular shape in the cross-section orthogonal to the central axis AX of the combustion tube 20. Thus, the fuel F injected from the fuel injection hole 114 forms a flame having the same shape as the spray shape 120. If the fuel F injected from the plurality of main nozzles 64 is ignited by the flame having such shape, it becomes difficult for the flame to fill the same cross-section in the combustor 3, suppressing occurrence of the combustion vibration. More specifically, with the pilot nozzle 54 according to some embodiments, it is possible to make the time until the fuel F injected from the plurality of main nozzles 64 at the same time becomes the flame and vibrates by contacting the inner wall of the combustion tube 20, and the contact position of the flame and the inner wall different depending on the circumferential position. Thus, the time when the vibration occurs and the axial position are dispersed, suppressing occurrence of the combustion vibration.

The pilot nozzle 54 according to some embodiments is configured to be able to inject the fuel F injected from the fuel injection hole 114 such that the spray shape 120 of the fuel F has the longest first major axis XL1 passing through the first centroid G1, and the first minor axis XS1 passing through the first centroid G1, as well as being orthogonal to the first major axis XL1 and shorter than the first major axis XL1, in the cross-section orthogonal to the central axis AX of the combustion tube 20.

In the pilot nozzle 54 according to some embodiments, the shape of the outer peripheral edge 114a of the fuel injection hole 114 as viewed from the axial direction may have the longest second major axis XL2 passing through the second centroid G2, and the second minor axis XS2 passing through the second centroid G2, as well as being orthogonal to the second major axis XL2 and shorter than the second major axis XL2.

According to such pilot nozzle 54, in the cross-section orthogonal to the central axis AX of the combustion tube 20, the spray shape 120 of the fuel F has the longest first major axis XL1 passing through the first centroid G1, and the first minor axis XS1 passing through the first centroid G1, as well as being orthogonal to the first major axis XL1 and shorter than the first major axis XL1. Thus, it becomes more difficult for the flame to fill the same cross-section in the combustor 3, effectively suppressing occurrence of the combustion vibration.

In the pilot nozzle 54 according to some embodiments, the spray shape 120 is the elliptical shape in the cross-section orthogonal to the central axis AX of the combustion tube 20.

In the pilot nozzle 54 according to some embodiments, the shape of the outer peripheral edge 114a as viewed from the axial direction may be the elliptical shape.

According to such pilot nozzle 54, the spray shape 120 of the fuel F can be the elliptical shape in the cross-section orthogonal to the central axis AX of the combustion tube 20. Thus, it is possible to easily implement the spray shape 120 of the fuel F capable of effectively suppressing occurrence of the combustion vibration. Further, since the shape of the fuel injection hole 114 is relatively simple, it is possible to suppress a manufacturing cost of the pilot nozzle 54.

In the pilot nozzle 54 according to some embodiments, the spray shape 120 in the cross-section orthogonal to the central axis AX of the combustion tube 20 preferably has the length ratio of the first minor axis XS1 to the first major axis XL1 which is not less than tan 15° and not greater than tan 30°.

In the pilot nozzle 54 according to some embodiments, the shape of the outer peripheral edge 114a as viewed from the axial direction may have the length ratio of the second minor axis SX2 to the second major axis XL2 which is not less than tan 15° and not greater than tan 30°.

As a result of intensive researches by the present inventors, it was found that, in the cross-section orthogonal to the central axis AX of the combustion tube 20, if the length ratio of the first minor axis XS1 to the first major axis XL1 of the spray shape 120 is not less than tan 15° and not greater than tan 30°, an effect of suppressing the combustion vibration is relatively high. Further, as described above, the spray shape 120 of the fuel F becomes the shape corresponding to the shape of the fuel injection hole 114. Therefore, according to such pilot nozzle 54, since the spray shape 120 approaches the shape in which the length ratio of the first minor axis XS1 to the first major axis XL1 is not less than tan 15° and not greater than tan 30°, it is possible to effectively suppress occurrence of the combustion vibration.

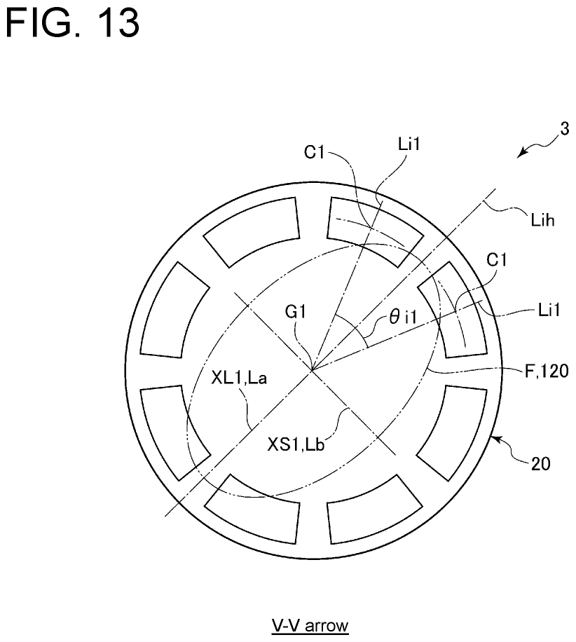

FIG. 13 is a schematic view of the cross-section orthogonal to the central axis AX of the combustion tube 20 at the axial position of the outlet opening 68b of the extension pipe 68 as viewed from the axially downstream side, and is a view showing the same cross-section as the V-V arrow cross-section in FIG. 3. For descriptive convenience, FIG. 13 omits the description of the configuration that is not necessary for describing the relationship between the outlet opening 68b of the extension pipe 68 and the spray shape 120 of the fuel F.

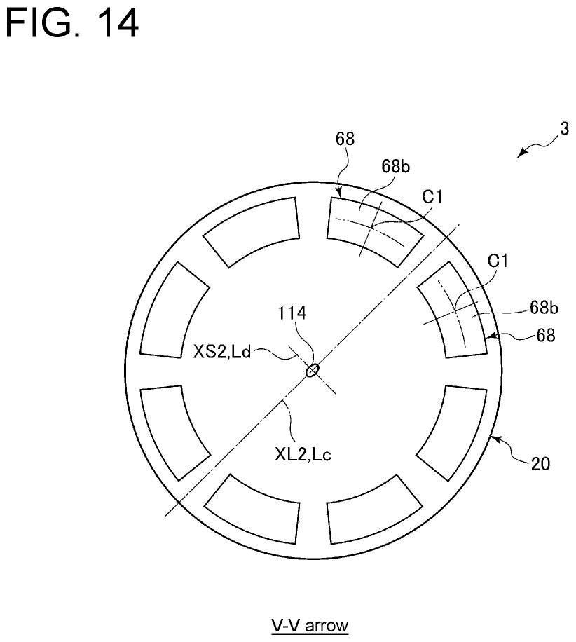

FIG. 14 is a schematic view of the cross-section orthogonal to the central axis AX of the combustion tube 20 at the axial position of the outlet opening 68b of the extension pipe 68 as viewed from the axially downstream side, and is a view showing the same cross-section as the V-V arrow cross-section in FIG. 3. For descriptive convenience, FIG. 14 omits the description of the configuration that is not necessary for describing the relationship between the outlet opening 68b of the extension pipe 68 and the fuel injection hole 114.

As shown in FIG. 13, in the pilot nozzle 54 according to some embodiments, the first major axis XL1 extends in a direction different from an extension direction of a first virtual line Li1 connecting the first centroid G1 and the center (centroid) C1 of the outlet opening 68b, in a cross-section of the cross-section orthogonal to the central axis AX of the combustion tube 20 where the outlet opening 68b of the extension pipe 68 exists.

As shown in FIG. 14, in the pilot nozzle 54 according to some embodiments, the second major axis XL2 may extend toward a position deviated from the circumferential center (centroid) C1 position of the outlet opening 68b in the circumferential direction, as viewed from the axial direction.

As a result of intensive researches by the present inventors, it was found that, in the cross-section of the cross-section orthogonal to the central axis AX of the combustion tube 20 where the outlet opening 68b of the extension pipe 68 exists, if the fuel F is injected such that the first major axis XL1 extends in the direction different from the extension direction of the first virtual line Li1 connecting the first centroid G1 and the center C1 of the outlet opening 68b, it is possible to effectively suppress the combustion vibration relative to a case where the fuel F is injected such that the first major axis LX1 extends in the same direction as the extension direction of the first virtual line Li1. Therefore, according to such pilot nozzle 54, since the fuel F can be injected such that the first major axis XL1 extends in the direction different from the extension direction of the first virtual line Li1, it is possible to effectively suppress the combustion vibration.

At the axial position of the outlet opening 68b of the extension pipe 68, if the first major axis XL1 is directed between the two outlet openings 68b adjacent to each other in the circumferential direction, it is possible to suppress the combustion vibration more effectively. Let a line segment Lih be a line segment bisecting an angle θi1 formed by the two first virtual lines Li1 for the two outlet openings 68b adjacent to each other in the circumferential direction. If a difference in angle between the first major axis XL1 (straight line La) and the line segment Lih is, for example, within 10°, it is possible to suppress the combustion vibration more effectively.

As shown in FIG. 6, in the pilot nozzle 54 according to some embodiments, the first major axis XL1 preferably extends toward an opening 22a of the connecting pipe 22 in a cross-section of the cross-section orthogonal to the central axis AX of the combustion tube 20 where the opening 22a of the connecting pipe 22 exists.

FIG. 6 is a schematic cross-sectional view in the VI arrow cross-section in FIG. 3, that is, a cross-sectional view at the axial position where the connecting pipe 22 exists.

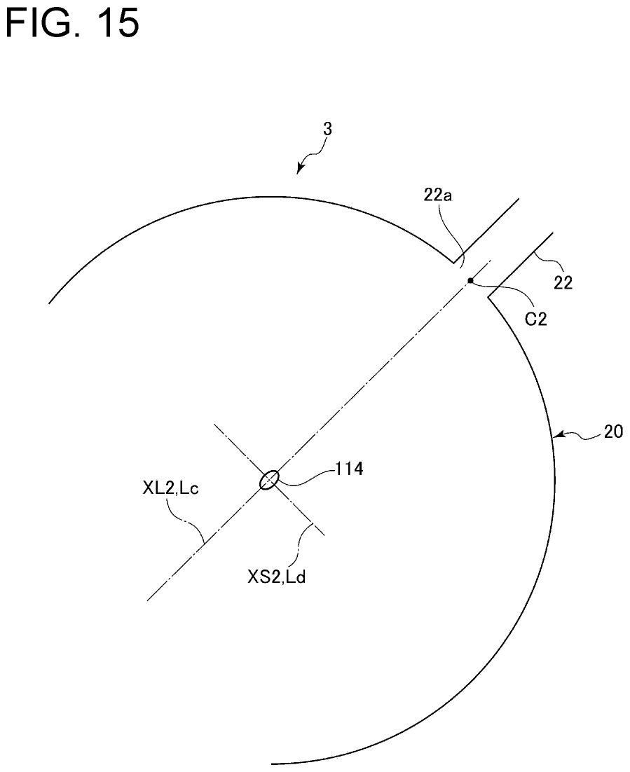

FIG. 15 is a cross-sectional view at the axial position where the connecting pipe 22 exists. For descriptive convenience, FIG. 15 omits the description of the configuration that is not necessary for describing the relationship between the opening 22a of the connecting pipe 22 and the fuel injection hole 114.

As shown in FIG. 15, the second major axis XL2 may extend toward the opening 22a of the connecting pipe 22 as viewed from the axial direction.

In the cross-section of the cross-section orthogonal to the central axis AX of the combustion tube 20 where the opening 22a of the connecting pipe 22 exists, injecting the fuel such that the first major axis XL1 extends toward the opening 22a of the connecting pipe 22, the flame easily propagates from one of the two adjacent combustors 3 to the other via the connecting pipe 22. Therefore, with the pilot nozzle 54 according to some embodiments, in the cross-section of the cross-section orthogonal to the central axis AX of the combustion tube 20 where the opening 22a of the connecting pipe 22 exists, it is possible to make the extension direction of the first major axis XL1 closer to the opening 22a of the connecting pipe 22, making it possible to obtain good propagation of the flame via the connecting pipe 22.

At the axial position of the opening 22a of the connecting pipe 22, if the difference in angle between the first major axis XL1 (straight line La) and the second virtual line Li2 (see FIG. 6) connecting the first centroid G1 and the center (centroid) C2 of the opening 22a is, for example, within 22.5°, it is possible to obtain good propagation of the flame via the connecting pipe 22.

(Regarding Swirl of Fuel F in Combustion Tube 20)

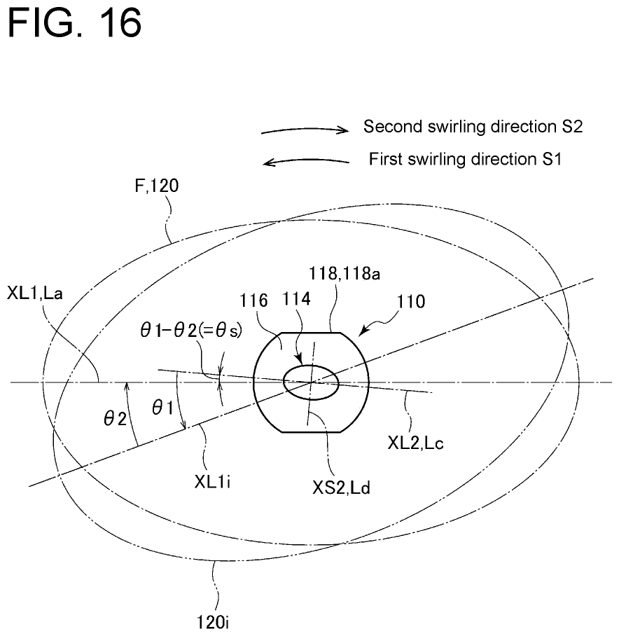

FIG. 16 is a schematic view for describing swirl of the fuel F in the combustion tube 20, and shows a state viewed from the axially downstream side toward the axially upstream side. FIG. 16 represents the spray shape 120 of the fuel F at the axial position where the connecting pipe 22 exists.

In some embodiments, the fuel F injected from the fuel injection hole 114 has a swirl velocity component that swirls in the circumferential direction centered on the axis AXs of the spray nozzle body 112, that is, the circumferential direction centered on the central axis AX of the combustion tube 20. Thus, the fuel F after being injected from the fuel injection hole 114 tends to swirl in the combustion tube 20 due to the swirl velocity component.

Further, the fuel F after being injected from the fuel injection hole 114 is influenced by the flow of the compressed air in the combustion tube 20. In the combustion tube 20, the compressed air is given a swirl velocity component that swirls in the circumferential direction centered on the central axis AX of the combustion tube 20 by the swirler (not shown) described above.

That is, the fuel F after being injected from the fuel injection hole 114 swirls in the combustion tube 20 due to the swirl velocity component of the fuel F and the influence by the flow of the compressed air swirling in the combustion tube 20.

For example, in the combustor 3 according to some embodiments, a swirling direction of the fuel F due to the swirl velocity component of the fuel F is a direction opposite to a swirling direction of the compressed air in the combustion tube 20. In the following description, the swirling direction of the fuel F due to the swirl velocity component of the fuel F will also be referred to as a first swirling direction S1, and the swirling direction opposite to the first swirling direction S1 will also be referred to as the second swirling direction S2.

As shown in FIG. 16, assuming that there is no influence by the flow of the compressed air swirling in the combustion tube 20, the fuel F after being injected from the fuel injection hole 114 swirls toward the first swirling direction S1 by an angle θ1 until it reaches the axial position where the connecting pipe 22 exists, like a spray shape 120i. That is, assuming that there is no influence by the flow of the compressed air swirling in the combustion tube 20, a virtual first major axis XL1i of the fuel F after being injected from the fuel injection hole 114 deviates from the second major axis XL2 by the angle θ1 in the first swirling direction S1.

However, in an operation of the gas turbine 1, the fuel F after being injected from the fuel injection hole 114 is pushed backward by an angle θ2 in the second swirling direction S2 until it reaches the axial position where the connecting pipe 22 exists. Therefore, in the operation of the gas turbine 1, the first major axis XL1 deviates from the second major axis XL 2 by an angle of “angle θ1-angle θ2” in the first swirling direction S1, until the fuel F after being injected from the fuel injection hole 114 reaches the axial position where the connecting pipe 22 exists. If (absolute value of angle θ2)<(absolute value of angle θ1), the fuel F after being injected from the fuel injection hole 114 swirls in the first swirling direction S1, and if (absolute value of angle θ1)<(absolute value of angle θ2), the fuel F after being injected from the fuel injection hole 114 swirls in the second swirling direction S2. If (absolute value of angle θ2)=(absolute value of angle θ1), the fuel F after being injected from the fuel injection hole 114 swirls neither in the first swirling direction S1 nor in the second swirling direction S2.

Therefore, it is desirable that the extension direction of the first major axis XL1 is a desired direction, in consideration of a swirling amount of the fuel F in the combustion tube 20 described above.

In some embodiments, the water W injected from the water injection hole 162 described above includes a velocity component toward the direction opposite to the swirling direction of the fuel F due to the swirl velocity component of the fuel F, that is, a velocity component toward the second swirling direction S2.

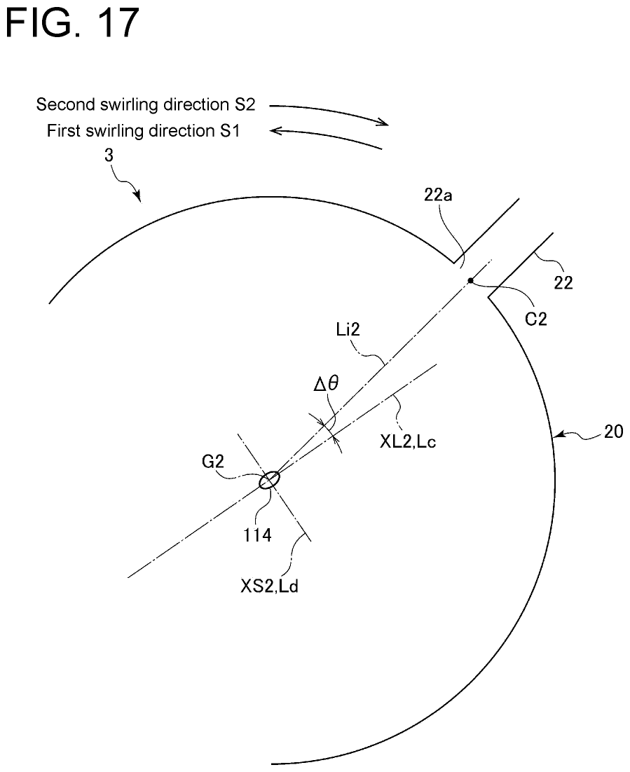

FIG. 17 is a cross-sectional view at the axial position where the connecting pipe 22 exists. For descriptive convenience, FIG. 17 omits the description of the configuration that is not necessary for describing the relationship between the opening 22a of the connecting pipe 22 and the fuel injection hole 114.

For example, as shown in FIG. 17, in some embodiments, the second major axis XL2 may deviate from the second virtual line Li2, which connects the second centroid G2 and the center C2 of the opening 22a of the connecting pipe 22, in the direction opposite to the first swirling direction S1, that is, the second swirling direction S2, as viewed from the axial direction.

If the fuel F injected from the fuel injection hole 114 has a velocity component to the circumferential direction, the fuel F flows toward the axially downstream side while swirling in the circumferential direction. Thus, if the fuel F has the velocity component to the circumferential direction, the direction of the first major axis XL1 changes depending on the axial position. For example, if a contribution by the velocity component to the circumferential direction of the fuel F is greater than a contribution by the flow of the compressed air swirling in the combustion tube 20, the first major axis XL1 swirls in the first swirling direction S1 toward the axially downstream side.

Even in such a case, as viewed from the axial direction, as long as the second major axis XL2 deviates from the second virtual line Li2 in the second swirling direction S2, in the cross-section of the cross-section orthogonal to the central axis AX of the combustion tube 20 where the opening 22a of the connecting pipe 22 exists, it is possible to make the extension direction of the first major axis XL1 closer to the opening 22a of the connecting pipe 22. Thus, it is possible to obtain good propagation of the flame via the connecting pipe 22.

Let a fuel swirling direction S and a fuel swirling angle θs, respectively, be a swirling direction and a swirling angle in which the fuel F from the fuel injection hole 114 actually swirls in the circumferential direction of the combustion tube 20 until it reaches the axial position where the opening 22a of the connecting pipe 22 exists.

As described above, the fuel swirling direction S and the fuel swirling angle θs are determined by the swirl velocity component of the fuel F and the influence by the flow of the compressed air swirling in the combustion tube 20.

In some embodiments, the second major axis XL2 preferably deviates from the second virtual line Li2 in the direction opposite to the fuel swirling direction S, as viewed from the axial direction. That is, in anticipation that the fuel F swirls in the circumferential direction in the combustion tube 20, the second major axis XL2 preferably deviates from the second virtual line Li2 in the direction opposite to the fuel swirling direction S. Then, a deviation amount AO of an angle between the second major axis XL2 and the second virtual line Li2 as viewed from the axial direction preferably falls within the range of ±5° relative to the fuel swirling angle θs.

Thus, in the cross-section of the cross-section orthogonal to the central axis AX of the combustion tube 20 where the opening 22a of the connecting pipe 22 exists, it is possible to make the extension direction of the first major axis XL1 closer to the opening 22a of the connecting pipe 22. More specifically, in the cross-section of the cross-section orthogonal to the central axis AX of the combustion tube 20 where the opening 22a of the connecting pipe 22 exists, it is possible to make a deviation amount of an angle between the extension direction of the first major axis XL1 and the second virtual line Li2 within the range of ±5°. Thus, it is possible to obtain good propagation of the flame via the connecting pipe 22.

With the gas turbine 1 including the combustor 3 according to some embodiments, it is possible to suppress the combustion vibration.

(Regarding Combustion Method for Oil Fuel)

In the gas turbine 1 including the combustor 3 according to some embodiments, oil fuel may be combusted by a combustion method for the oil fuel to be described below.

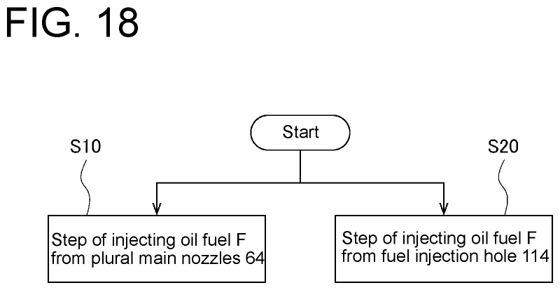

FIG. 18 is a flowchart showing a processing procedure in the combustion method for the oil fuel according to an embodiment.

The combustion method for the oil fuel according to an embodiment includes a step S10 of injecting the oil fuel F from the plurality of main nozzles 64 and a step S20 of injecting the oil fuel F from the fuel injection hole 114 of the pilot nozzle 54.

In the combustion method for the oil fuel according to an embodiment, the step S20 of injecting the oil fuel F from the fuel injection hole 114 includes injecting the oil fuel F injected from the fuel injection hole 114 such that the spray shape 120 of the oil fuel F has the longest first major axis XL1 passing through the first centroid G1 of the spray shape 120, and the first minor axis XS1 passing through the first centroid G1, as well as being orthogonal to the first major axis XL1 and shorter than the first major axis XL1, in the cross-section orthogonal to the central axis AX of the combustion tube 20.

According to the combustion method for the oil fuel according to an embodiment, since the spray shape 120 of the fuel F has the first major axis XL1 and the first minor axis XS1 described above in the cross-section orthogonal to the central axis AX of the combustion tube 20, as described above, it is more difficult for the flame to fill the same cross-section in the combustor 20, effectively suppressing occurrence of the combustion vibration.

The present disclosure is not limited to the above-described embodiments, and also includes an embodiment obtained by modifying the above-described embodiments and an embodiment obtained by combining these embodiments as appropriate.

The contents described in the above embodiments would be understood as follows, for instance.

(1) A gas turbine combustor (combustor 3) according to at least one embodiment of the present disclosure includes a first burner (main burner 60) with a plurality of first nozzles (main nozzles 64) disposed along an inner circumference of a cylindrical combustion tube 20. The combustor 3 according to at least one embodiment of the present disclosure includes a second nozzle (pilot nozzle 54) surrounded by the plurality of main nozzles 64.

The pilot nozzle 54 has a fuel injection hole 114 capable of injecting fuel F.

A distance Ln between a centroid (second centroid G2) of the fuel injection hole 114 and an outer peripheral edge 114a of the fuel injection hole 114 as viewed from an axial direction of the combustion tube 20 differs depending on a position of the outer peripheral edge 114a in a circumferential direction of the combustion tube 20.

With the above configuration (1), since the pilot nozzle 54 has the above-described fuel injection hole 114, as described above, if the fuel F is injected from the fuel injection hole 114 in the axial direction of the combustion tube 20, the spray shape 120 of the fuel F becomes a shape corresponding to the shape of the fuel injection hole 114. More specifically, the spray shape 120 of the fuel F is configured such that, in the cross-section orthogonal to the central axis AX of the combustion tube 20, the distance Lf between the first centroid G1, which is the centroid of the spray shape 120, and the outer edge 121 of the spray shape 120 differs depending on the position of the outer edge 121 of the spray shape 120 in the circumferential direction of the combustion tube 20. That is, the spray shape of the fuel F is not a circular shape in the cross-section orthogonal to the central axis AX of the combustion tube 20. Thus, the fuel F injected from the above-described fuel injection hole 114 forms a flame having the same shape as the spray shape 120 described above. If the fuel F injected from the plurality of main nozzles 64 is ignited by the flame having such shape, it becomes difficult for the flame to fill the same cross-section in the combustor 3, suppressing occurrence of the combustion vibration. More specifically, with the above configuration (1), it is possible to make the time until the fuel F injected from the plurality of main nozzles 64 at the same time becomes the flame and vibrates by contacting the inner wall of the combustion tube 20, and the contact position of the flame and the inner wall different depending on the circumferential position. Thus, the time when the vibration occurs and the axial position are dispersed, suppressing occurrence of the combustion vibration.

(2) In some embodiments, in the above configuration (1), a shape of the outer peripheral edge 114a as viewed from the axial direction has a longest major axis (second major axis XL2) passing through the centroid (second centroid G2), and a minor axis (second minor axis XS2) passing through the second centroid G2, as well as being orthogonal to the second major axis XL2 and shorter than the second major axis XL2.

As described above, the spray shape 120 of the fuel F becomes the shape corresponding to the shape of the fuel injection hole 114. Therefore, with the above configuration (2), in the cross-section orthogonal to the central axis AX of the combustion tube 20, the spray shape 120 of the fuel F has the longest first major axis XL1 passing through the first centroid G1 which is the centroid of the spray shape 120, and the first minor axis XS1 passing through the first centroid G1, as well as being orthogonal to the first major axis XL1 and shorter than the first major axis XL1. Thus, it becomes more difficult for the flame to fill the same cross-section in the combustor 3, effectively suppressing occurrence of the combustion vibration.

(3) In some embodiments, in the above configuration (2), the shape of the outer peripheral edge 114a as viewed from the axial direction is an elliptical shape.

With the above configuration (3), the spray shape 120 of the fuel F can be the elliptical shape in the cross-section orthogonal to the central axis AX of the combustion tube 20. Thus, it is possible to easily implement the spray shape 120 of the fuel F capable of effectively suppressing occurrence of the combustion vibration. Further, since the shape of the fuel injection hole 114 is relatively simple, it is possible to suppress a manufacturing cost of the pilot nozzle 54.

(4) In some embodiments, in the above configuration (2) or (3), the shape of the outer peripheral edge 114a as viewed from the axial direction has a length ratio of the second minor axis XS2 to the second major axis XL2 which is not less than tan 15° and not greater than tan 30°.

As described above, as a result of intensive researches by the present inventors, it was found that, in the cross-section orthogonal to the central axis AX of the combustion tube 20, if the length ratio of the first minor axis XS1 to the first major axis XL1 of the spray shape 120 is not less than tan 15° and not greater than tan 30°, an effect of suppressing the combustion vibration is relatively high. Further, as described above, the spray shape 120 of the fuel F becomes the shape corresponding to the shape of the fuel injection hole 114. Therefore, with the above configuration (4), since the spray shape 120 approaches the shape in which the length ratio of the first minor axis XS1 to the first major axis XL1 is not less than tan 15° and not greater than tan 30, it is possible to effectively suppress occurrence of the combustion vibration.

(5) In some embodiments, in any one of the above configurations (2) to (4), the combustor 3 further includes a plurality of extension pipes 68 each having an inlet opening 68a that coincides with an outlet side opening 66b of a first nozzle tube (main nozzle tube 66) surrounding each of the main nozzles 64, and an annular fan-shaped outlet opening 68b. The second major axis XL2 extends toward a position deviated, in the circumferential direction, from a center (centroid) C1 position of the outlet opening 68b in the circumferential direction, as viewed from the axial direction.

As described above, as a result of intensive researches by the present inventors, it was found that, in the cross-section of the cross-section orthogonal to the central axis AX of the combustion tube 20 where the outlet opening 68b of the extension pipe 68 exists, if the fuel F is injected such that the first major axis XL1 extends in the direction different from the extension direction of the first virtual line Li1 connecting the first centroid G1 and the center of the outlet opening 68b described above, it is possible to effectively suppress the combustion vibration relative to a case where the fuel F is injected such that the first major axis XL1 extends in the same direction as the extension direction of the first virtual line Li1. Therefore, with the above configuration (5), since the fuel F can be injected such that the first major axis XL1 extends in the direction different from the extension direction of the first virtual line Li1, it is possible to effectively suppress the combustion vibration.

(6) In some embodiments, in any one of the above configurations (2) to (5), the combustor 3 further includes an atomizing cap 160 with a plurality of water injection holes 162 capable of injecting water W.

The plurality of water injection holes 162 have water inlet openings 164 and water outlet openings 166, respectively.

The water outlet openings 166 are disposed at intervals along the circumferential direction on an outer side of the fuel injection hole 114 in a radial direction of the combustion tube 20.

Positions of the water inlet openings 164 in the radial direction differ depending on positions of the water outlet openings 166 in the circumferential position, respectively.

With the above configuration (6), since the positions of the water inlet openings 164 in the radial direction differ depending on the positions of the water outlet openings 166 in the circumferential position, respectively, it is possible to inject the water W along the injection direction of the fuel F in the radially outward region of the fuel F injected from the fuel injection hole 114. Thus, it is possible to suppress generation of nitrogen oxides due to combustion of the fuel F, while suppressing an influence on the spray shape 120 of the fuel F by the injected water W.

(7) In some embodiments, in any one of the above configurations (2) to (6), a plurality of combustors 3 are disposed in an annular shape around a rotor 5 of a gas turbine 1.

Each of the plurality of combustors 3 is mounted with a connecting pipe 22 for propagating a flame from one of two adjacent combustors 3 to the other.

The second major axis XL2 extends toward an opening 22a of the connecting pipe 22 as viewed from the axial direction.

In the cross-section of the cross-section, where the first major axis XL1 in the spray shape 120 described above is orthogonal to the central axis AX of the combustion tube 20, where the opening 22a of the connecting pipe 22 exists, injecting the fuel F to extend toward the opening 22a of the connecting pipe 22, the flame easily propagates from one of the two adjacent combustors 3 to the other via the connecting pipe 22. Therefore, with the above configuration (7), in the cross-section of the cross-section orthogonal to the central axis AX of the combustion tube 20 where the opening 22a of the connecting pipe 22 exists, it is possible to make the extension direction of the first major axis XL1 closer to the opening 22a of the connecting pipe 22, making it possible to obtain good propagation of the flame via the connecting pipe 22.

(8) In some embodiments, in any one of the above configurations (2) to (6), a plurality of combustors 3 are disposed in an annular shape around a rotor 5 of a gas turbine 1.

Each of the plurality of combustors 3 is mounted with a connecting pipe 22 for propagating a flame from one of two adjacent combustors 3 to the other.

Let a first swirling direction S1 be a direction in which the fuel F injected from the fuel injection hole 114 swirls due to a velocity component of the fuel F to the circumferential direction.

The second major axis XL2 deviates from a second virtual line Li2, which connects the second centroid G2 and a center C2 of the opening 22a of the connecting pipe 22, in a direction opposite to the first swirling direction S1, as viewed from the axial direction.

If the fuel F injected from the fuel injection hole 114 has a velocity component to the circumferential direction, the fuel F flows toward the axially downstream side while swirling in the circumferential direction. Thus, if the fuel F has the velocity component to the circumferential direction, the direction of the first major axis XL1 changes depending on the axial position.

With the above configuration (8), even if the fuel F has the velocity component to the circumferential direction, in the cross-section of the cross-section orthogonal to the central axis of the combustion tube 20 where the opening 22a of the connecting tube 22 exists, it is possible to make the extension direction of the first major axis XL1 closer to the opening 22a of the connecting tube 22. Thus, it is possible to obtain good propagation of the flame via the connecting pipe 22.

(9) A combustor 3 according to at least one embodiment of the present disclosure includes a main burner 60 with a plurality of main nozzles 64 disposed along an inner circumference of a cylindrical combustion tube, and a pilot nozzle 54 surrounded by the plurality of main nozzles 64.

The pilot nozzle 54 has a fuel injection hole 114 capable of injecting fuel F. The pilot nozzle 54 is capable of injecting the fuel F injected from the fuel injection hole 114 such that a spray shape 120 of the fuel F has a longest first major axis XL1 passing through a first centroid G1 which is a centroid of the spray shape 120, and a first minor axis XS1 passing through the first centroid G1, as well as being orthogonal to the first major axis XL1 and shorter than the first major axis XL1, in a cross-section orthogonal to a central axis AX of the combustion tube 20.

With the above configuration (9), since the spray shape 120 of the fuel F has the first major axis XL1 and the first minor axis XS1 in the cross-section orthogonal to the central axis AX of the combustion tube 20, as described above, it is more difficult for the flame to fill the same cross-section in the combustor 3, effectively suppressing occurrence of the combustion vibration.

(10) In some embodiments, in the above configuration (9), the spray shape 120 is an elliptical shape in the cross-section orthogonal to the central axis AX of the combustion tube 20.

With the above configuration (10), since the spray shape 120 of the fuel F has the elliptical shape in the cross-section orthogonal to the central axis AX of the combustion tube 20, as described above, it is more difficult for the flame to fill the same cross-section in the combustor 3, effectively suppressing occurrence of the combustion vibration.

(11) In some embodiments, in the above configuration (9) or (10), the spray shape 120 in the cross-section orthogonal to the central axis AX of the combustion tube 20 has a length ratio of the first minor axis XS1 to the first major axis XL1 which is not less than tan 15° and not greater than tan 30°.

As described above, as a result of intensive researches by the present inventors, it was found that, in the cross-section orthogonal to the central axis AX of the combustion tube 20, if the length ratio of the first minor axis XS1 to the first major axis XL1 of the spray shape 120 is not less than tan 15° and not greater than tan 30°, an effect of suppressing the combustion vibration is relatively high. Therefore, with the above configuration (11), it is possible to effectively suppress occurrence of the combustion vibration.

(12) In some embodiments, in any one of the above configurations (9) to (11), the combustor 3 further includes a plurality of extension pipes 68 each having an inlet opening 68a that coincides with an outlet side opening 66b of a main nozzle tube 66 surrounding each of the main nozzles 64, and an annular fan-shaped outlet opening 68b.

The first major axis XL1 of the spray shape 120 extends in a direction different from an extension direction of a first virtual line Li1 connecting the first centroid G1 and a center of the outlet opening 68b, in a cross-section of the cross-section orthogonal to the central axis AX of the combustion tube 20 where the outlet opening 68b exists.

As described above, as a result of intensive researches by the present inventors, it was found that, in the cross-section of the cross-section orthogonal to the central axis AX of the combustion tube 20 where the outlet opening 68b of the extension pipe 68 exists, if the fuel F is injected such that the first major axis XL1 extends in the direction different from the extension direction of the first virtual line Li1, it is possible to effectively suppress the combustion vibration relative to a case where the fuel F is injected such that the first major axis XL1 extends in the same direction as the extension direction of the first virtual line Li1. Therefore, with the above configuration (12), it is possible to effectively suppress the combustion vibration.

(13) In some embodiments, in any one of the above configurations (9) to (12), the combustor 3 further includes an atomizing cap 160 with a plurality of water injection holes 162 capable of injecting water W.

The plurality of water injection holes 162 have water inlet openings 164 and water outlet openings 166, respectively.

The water outlet openings 166 are disposed at intervals along a circumferential direction of the combustion tube 20 on an outer side of the fuel injection hole 114 in a radial direction of the combustion tube 20.

Positions of the water inlet openings 164 in the radial direction differ depending on positions of the water outlet openings 166 in the circumferential position, respectively.

With the above configuration (13), since the positions of the water inlet openings 164 in the radial direction differ depending on the positions of the water outlet openings 166 in the circumferential position, respectively, it is possible to inject the water W along the injection direction of the fuel F in the radially outward region of the fuel F injected from the fuel injection hole 114. Thus, it is possible to suppress generation of nitrogen oxides due to combustion of the fuel F, while suppressing an influence on the spray shape 120 of the fuel F by the injected water W.

(14) In some embodiments, in any one of the above configurations (9) to (13), a plurality of combustors 3 are disposed in an annular shape around a rotor 5 of a gas turbine 1.

Each of the plurality of combustors 3 is mounted with a connecting pipe 22 for propagating a flame from one of two adjacent combustors 3 to the other.

The first major axis XL1 of the spray shape 120 extends toward an opening 22a of the connecting pipe 22 in a cross-section of the cross-section orthogonal to the central axis AX of the combustion tube 20 where the opening 22a of the connecting pipe 22 exists.

With the above configuration (14), it is possible to obtain good propagation of the flame via the connecting pipe 22.

(15) In some embodiments, in any one of the above configurations (9) to (14), a plurality of combustors 3 are disposed in an annular shape around a rotor 5 of a gas turbine 1.

Each of the plurality of combustors 3 is mounted with a connecting pipe 22 for propagating a flame from one of two adjacent combustors 3 to the other.

A shape of the outer peripheral edge 114a of the fuel injection hole 114 as viewed from an axial direction of the combustion tube 20 has a longest second major axis XL2 passing through a second centroid G2 which is a centroid of the fuel injection hole 114, and a second minor axis XS2 passing through the second centroid G2, as well as being orthogonal to the second major axis XL2 and shorter than the second major axis XL2.

Let a first swirling direction S1 be a direction in which the fuel F injected from the fuel injection hole 114 swirls due to a velocity component of the fuel F to the circumferential direction of the combustion tube 20.

The second major axis XL2 deviates from a second virtual line Li2, which connects the second centroid G2 and a center C2 of the opening 22a of the connecting pipe 22, in a direction opposite to the first swirling direction S1, as viewed from the axial direction.

With the above configuration (15), even if the fuel F injected from the fuel injection hole 114 has the velocity component to the circumferential direction, in the cross-section of the cross-section orthogonal to the central axis AX of the combustion tube 20 where the opening 22a of the connecting tube 22 exists, it is possible to make the extension direction of the first major axis XL1 closer to the opening 22a of the connecting tube 22. Thus, it is possible to obtain good propagation of the flame via the connecting pipe 22.

(16) In some embodiments, in any one of the above configurations (9) to (14), a plurality of combustors 3 are disposed in an annular shape around a rotor 5 of a gas turbine 1.

Each of the plurality of combustors 3 is mounted with a connecting pipe 22 for propagating a flame from one of two adjacent combustors 3 to the other.

A shape of the outer peripheral edge 114a of the fuel injection hole 114 as viewed from an axial direction of the combustion tube 20 has a longest second major axis XL2 passing through a second centroid G2 which is a centroid of the fuel injection hole 114, and a second minor axis XS2 passing through the second centroid G2, as well as being orthogonal to the second major axis XL2 and shorter than the second major axis XL2.

Let a fuel swirling direction S and a fuel swirling angle θs be a swirling direction and a swirling angle, respectively, in which the fuel F from the fuel injection hole 114 swirls in a circumferential direction of the combustion tube 20 until the fuel F reaches a position in the axial direction where the opening 22a of the connecting pipe 22 exists.

The second major axis XL2 deviates from a second virtual line Li2, which connects the second centroid G2 and a center C2 of the opening 22a of the connecting pipe 22, in a direction opposite to the fuel swirling direction S, as viewed from the axial direction.

A deviation amount AO of an angle between the second major axis XL2 and the second virtual line Li2 as viewed from the axial direction falls within a range of ±5° relative to the fuel swirling angle θs.

With the above configuration (16), in the cross-section of the cross-section orthogonal to the central axis AX of the combustion tube 20 where the opening 22a of the connecting pipe 22 exists, it is possible to make the extension direction of the first major axis XL1 closer to the opening 22a of the connecting pipe 22. Thus, it is possible to obtain good propagation of the flame via the connecting pipe 22.

(17) A gas turbine 1 according to at least one embodiment of the present disclosure includes a rotor 5, and a plurality of combustors 3 according to any one of the above configurations (1) to (16) disposed in an annular shape around the rotor 5.

With the above configuration (17), it is possible to suppress the combustion vibration.

(18) A combustion method for oil fuel according to at least one embodiment of the present disclosure is a combustion method for oil fuel in a gas turbine 1.

The combustion method for the oil fuel according to an embodiment includes a step S10 of injecting the oil fuel F from a plurality of main nozzles 64 disposed along an inner circumference of a cylindrical combustion tube 20 in a main burner 60 with the plurality of main nozzles 64.

The combustion method for the oil fuel according to an embodiment includes a step S20 of injecting the oil fuel F from a fuel injection hole 114 of a pilot nozzle 54 surrounded by the plurality of main nozzles 64.

The step S20 of injecting the oil fuel F from the fuel injection hole 114 includes injecting the oil fuel F injected from the fuel injection hole 114 such that a spray shape 120 of the oil fuel F a longest first major axis XL1 passing through a first centroid G1 of the spray shape 120, and a first minor axis XS1 passing through the first centroid G1, as well as being orthogonal to the first major axis XL1 and shorter than the first major axis XL1, in a cross-section orthogonal to a central axis AX of the combustion tube 20.

With the above method (18), since the spray shape 120 of the fuel F has the first major axis XL1 and the first minor axis XS1 in the cross-section orthogonal to the central axis AX of the combustion tube 20, as described above, it is more difficult for the flame to fill the same cross-section in the combustor 3, effectively suppressing occurrence of the combustion vibration.

### REFERENCE SIGNS LIST

1 Gas turbine
3 Combustor
5 Rotor
20 Combustion tube
22 Connecting pipe
50 Pilot burner
54 Pilot nozzle
60 Main burner
64 64 Main nozzle
68 Extension pipe
110 Spray nozzle
114 Fuel injection hole
160 Atomizing cap
162 Water injection hole

1. A gas turbine combustor, comprising:
a first burner with a plurality of first nozzles disposed along an inner circumference of a cylindrical combustion tube; and
a second nozzle surrounded by the plurality of first nozzles,
wherein the second nozzle has a fuel injection hole capable of injecting fuel, and
wherein a distance between a centroid of the fuel injection hole and an outer peripheral edge of the fuel injection hole as viewed from an axial direction of the combustion tube differs depending on a position of the outer peripheral edge in a circumferential direction of the combustion tube.

2. The gas turbine combustor according to claim 1,
wherein a shape of the outer peripheral edge as viewed from the axial direction has a longest major axis passing through the centroid, and a minor axis passing through the centroid, as well as being orthogonal to the major axis and shorter than the major axis.

3. The gas turbine combustor according to claim 2,
wherein the shape of the outer peripheral edge as viewed from the axial direction is an elliptical shape.

4. The gas turbine combustor according to claim 2,
wherein the shape of the outer peripheral edge as viewed from the axial direction has a length ratio of the minor axis to the major axis which is not less than tan 15° and not greater than tan 30°.

5. The gas turbine combustor according to claim 2, further comprising:
a plurality of extension pipes each having an inlet opening that coincides with an outlet side opening of a first nozzle tube surrounding each of the first nozzles, and an annular fan-shaped outlet opening,
wherein the major axis extends toward a position deviated, in the circumferential direction, from a center position of the outlet opening in the circumferential direction, as viewed from the axial direction.

6. The gas turbine combustor according to claim 2, further comprising:
an atomizing cap with a plurality of water injection holes capable of injecting water,
wherein the plurality of water injection holes have water inlet openings and water outlet openings, respectively,
wherein the water outlet openings are disposed at intervals along the circumferential direction on an outer side of the fuel injection hole in a radial direction of the combustion tube, and
wherein positions of the water inlet openings in the radial direction differ depending on positions of the water outlet openings in the circumferential position, respectively.

7. The gas turbine combustor according to claim 2,
wherein a plurality of gas turbine combustors are disposed in an annular shape around a rotor of a gas turbine,
wherein each of the plurality of gas turbine combustors is mounted with a connecting pipe for propagating a flame from one of two adjacent gas turbine combustors to the other, and
wherein the major axis extends toward an opening of the connecting pipe as viewed from the axial direction.

8. The gas turbine combustor according to claim 2,
wherein a plurality of gas turbine combustors are disposed in an annular shape around a rotor of a gas turbine,
wherein each of the plurality of gas turbine combustors is mounted with a connecting pipe for propagating a flame from one of two adjacent gas turbine combustors to the other, and
wherein when a direction, in which the fuel injected from the fuel injection hole swirls due to a velocity component of the fuel to the circumferential direction, is a first swirling direction,
the major axis deviates from a virtual line, which connects the centroid and a center of the opening of the connecting pipe, in a direction opposite to the first swirling direction, as viewed from the axial direction.

9. A gas turbine combustor, comprising:
a first burner with a plurality of first nozzles disposed along an inner circumference of a cylindrical combustion tube; and
a second nozzle surrounded by the plurality of first nozzles,
wherein the second nozzle
has a fuel injection hole capable of injecting fuel, and
is capable of injecting the fuel injected from the fuel injection hole such that a spray shape of the fuel has a longest first major axis passing through a first centroid which is a centroid of the spray shape, and a first minor axis passing through the first centroid, as well as being orthogonal to the first major axis and shorter than the first major axis, in a cross-section orthogonal to a central axis of the combustion tube.

10. The gas turbine combustor according to claim 9,
wherein the spray shape is an elliptical shape in the cross-section orthogonal to the central axis of the combustion tube.

11. The gas turbine combustor according to claim 9,
wherein the spray shape in the cross-section orthogonal to the central axis of the combustion tube has a length ratio of the first minor axis to the first major axis which is not less than tan 15° and not greater than tan 30°.

12. The gas turbine combustor according to claim 9, further comprising:
a plurality of extension pipes each having an inlet opening that coincides with an outlet side opening of a first nozzle tube surrounding each of the first nozzles, and an annular fan-shaped outlet opening,
wherein the first major axis of the spray shape extends in a direction different from an extension direction of a first virtual line connecting the first centroid and a center of the outlet opening, in a cross-section of the cross-section orthogonal to the central axis of the combustion tube where the outlet opening exists.

13. The gas turbine combustor according to claim 9, further comprising:
an atomizing cap with a plurality of water injection holes capable of injecting water,
wherein the plurality of water injection holes have water inlet openings and water outlet openings, respectively,
wherein the water outlet openings are disposed at intervals along a circumferential direction of the combustion tube on an outer side of the fuel injection hole in a radial direction of the combustion tube, and
wherein positions of the water inlet openings in the radial direction differ depending on positions of the water outlet openings in the circumferential position, respectively.

14. The gas turbine combustor according to claim 9,
wherein a plurality of gas turbine combustors are disposed in an annular shape around a rotor of a gas turbine,
wherein each of the plurality of gas turbine combustors is mounted with a connecting pipe for propagating a flame from one of two adjacent gas turbine combustors to the other, and
wherein the first major axis of the spray shape extends toward an opening of the connecting pipe in a cross-section of the cross-section orthogonal to the central axis of the combustion tube where the opening of the connecting pipe exists.

15. The gas turbine combustor according to claim 9,
wherein a plurality of gas turbine combustors are disposed in an annular shape around a rotor of a gas turbine,
wherein each of the plurality of gas turbine combustors is mounted with a connecting pipe for propagating a flame from one of two adjacent gas turbine combustors to the other,
wherein a shape of the outer peripheral edge of the fuel injection hole as viewed from an axial direction of the combustion tube has a longest second major axis passing through a second centroid which is a centroid of the fuel injection hole, and a second minor axis passing through the second centroid, as well as being orthogonal to the second major axis and shorter than the second major axis, and
wherein when a direction, in which the fuel injected from the fuel injection hole swirls due to a velocity component of the fuel to the circumferential direction of the combustion tube, is a first swirling direction,
the second major axis deviates from a second virtual line, which connects the second centroid and a center of the opening of the connecting pipe, in a direction opposite to the first swirling direction, as viewed from the axial direction.

16. The gas turbine combustor according to claim 9,
wherein a plurality of gas turbine combustors are disposed in an annular shape around a rotor of a gas turbine,
wherein each of the plurality of gas turbine combustors is mounted with a connecting pipe for propagating a flame from one of two adjacent gas turbine combustors to the other,
wherein a shape of the outer peripheral edge of the fuel injection hole as viewed from an axial direction of the combustion tube has a longest second major axis passing through a second centroid which is a centroid of the fuel injection hole, and a second minor axis passing through the second centroid, as well as being orthogonal to the second major axis and shorter than the second major axis,
wherein when a swirling direction and a swirling angle, in which the fuel from the fuel injection hole swirls in a circumferential direction of the combustion tube until the fuel reaches a position in the axial direction where the opening of the connecting pipe exists, are a fuel swirling direction and a fuel swirling angle, respectively,
the second major axis deviates from a virtual line, which connects the second centroid and a center of the opening of the connecting pipe, in a direction opposite to the fuel swirling direction, as viewed from the axial direction, and
wherein a deviation amount of an angle between the second major axis and the virtual line as viewed from the axial direction falls within a range of ±5° relative to the fuel swirling angle.

17. A gas turbine, comprising:
a rotor; and
a plurality of combustors according to claim 1 disposed in an annular shape around the rotor.

18. A combustion method for oil fuel in a gas turbine, comprising:
a step of injecting the oil fuel from a plurality of first nozzles disposed along an inner circumference of a cylindrical combustion tube in a first burner with the plurality of first nozzles; and
a step of injecting the oil fuel from a fuel injection hole of a second nozzle surrounded by the plurality of first nozzles,
wherein the step of injecting the oil fuel from the fuel injection hole includes injecting the oil fuel injected from the fuel injection hole such that a spray shape of the oil fuel has a longest major axis passing through a centroid of the spray shape, and a minor axis passing through the centroid, as well as being orthogonal to the major axis and shorter than the major axis, in a cross-section orthogonal to a central axis of the combustion tube.
